(19) United States
(12) Patent Application Publication
(10) Pub. No.: US 2021/0012289 A1
(43) Pub. Date: Jan. 14, 2021

(54) ONLINE CONTRACT SIGNING SYSTEM AND METHOD

(71) Applicant: CHING-JU HSIEH, ZHUBEI CITY (TW)

(72) Inventor: CHING-JU HSIEH, ZHUBEI CITY (TW)

(21) Appl. No.: 16/699,213

(22) Filed: Nov. 29, 2019

(30) Foreign Application Priority Data
Jul. 12, 2019 (TW) 108124783

(51) Int. Cl. G06Q 10/10; H04L 12/18; H04L 12/58; H04L 29/06

(52) U.S. Cl. CPC G06Q 10/109; H04L 65/403; H04L 51/04; H04L 12/1818

(57) ABSTRACT

An online contract signing system and method are disclosed. The online contract signing system can generate a contract document according to data input by a contract initiator and transmitting a link of a contract chatroom to terminal devices of the contract initiator and at least one invitee via their contact information. After the contract initiator and the invitee joined the contract chatroom, a document reading and discussion service is provided to all of them, and a document updating service is provided to at least one of the contract initiator and the invitee, wherein the online contract signing system allows the contract initiator to explain the content of the contract document to the invitee and when the invitee has concerns, the contract document can be updated. Once an agreement is reached, the online contract signing system provides an online signing service for everyone to sign the agreed contract document.

### REFERENCE TO RELATED APPLICATIONS

This non-provisional application claims priority claim under 35 U.S.C. § 119(a) on Taiwan Patent Application No. 108124783, filed Jul. 12, 2019, the entire contents of which are incorporated herein by reference.

### FIELD OF THE INVENTION

The invention relates to an online contract signing system and method, more particularly, to an online signing system and method that allow a contract initiator to explain, online, the content of a contract document to an invitee and updates the contract document in real time based on the invitee's opinion, so as to increase the rate of successful contracts.

### BACKGROUND

A contract is an agreement which binds the signing parties to their obligations and rights. Nowadays there are many contract documents in our daily lives, and especially for business man with a lot more commercial events than an average person, reviewing and signing contracts is a norm.

However, current way of signing a contract is usually done by mailing the contract document to the parties first, and through discussion, the terms in the contract document are amended. And after the parties have reached an agreement, the agreed contract is printed out and signed. But because the discussion of the contract terms was not carried out in person by the parties, there may be an issue of the contract amendment not matching what was discussed in the discussion, and thus it would take longer for the parties to agree upon the terms and thereby reducing the rate of successful contracts.

Another way of signing a contract is for the parties to meet in person with a printed copy of the contract, discuss and edit the printed contract at the meeting, and then amend the electronic file of the contract accordingly before printing it out for signature. This method requires the parties to meet, but if the parties are distant apart from each other or the meeting time is difficult to arrange, then it is inconvenient to the parties and increases the time and cost of signing a contract.

### SUMMARY

It is then an object of the invention to provide an online contract signing system which includes a server. The server includes a plurality of hardware circuits electrically connected to one another, wherein the server executes a program code via the plurality of hardware circuits to provide a contract document, a contract chatroom, a document reading and discussion service, and a document updating service. The contract document and the contract chatroom are creatable by a contract initiator. The document reading and discussion service is provided to the contract initiator and at least one invitee who joined the contract chatroom, whereas the document updating service is provided to at least one of the contract initiator and the invitee. Under control of the server, one of terminal devices of the contract initiator or the invitee is a sink side, and another one of the terminal devices of the contract initiator or the invitee is a control side.

Optionally, the server further provides an online signing service for the contract initiator and the invitee to sign the contract document mutually agreed by, the contract initiator and the invitee.

Optionally, the contract initiator inputs contact information of the contract initiator and the invitee, and the server transmits a link of the contract chatroom to the terminal devices of the contract initiator and the invitee via the contact information.

Optionally, the server further transmits a password or a password getting for joining the contract chatroom to the terminal devices of the contract initiator and the invitee via the contact information.

Optionally, the server further allows at least one of the contract initiator and the invitee to abandon the contract document and the server terminates the contract chatroom.

Optionally, the document updating service includes updating terms of contract, updating general data, uploading photos and importing lists, and after the contract document is updated, the server displays the updated contract document in the contract chatroom.

Optionally, the server translates a text of the contract document into a target text corresponding to a language preference of the invitee.

Optionally, the document reading and discussion service includes allowing the contract initiator and the invitee to communicate by inputting text messages or voice messages.

Optionally, a software infrastructure of the online contract signing system is Software as a Service.

Optionally, the server further records a meeting minutes of the contract chatroom.

Optionally, the password is an one-time password for use at a specific time.

Another object of the invention is to provide an online contract signing method with the following steps. A contract document and a contract chatroom creatable by a contract initiator are provided. A document reading and discussion service is provided to the contract initiator and at least one invitee who joined the contract chatroom, and a document updating service is provided to at least one of the contract initiator and the invitee. One of the terminal devices of the contract initiator or the invitee, which is provided with the document updating service, is controlled to act as a control side, and another one of the terminal devices of the contract initiator or the invitee, which is provided with the document reading and discussion service, is controlled to act as a sink side

In short, the invention provides an online contract signing system and method that reduce time and cost spent on discussing contract terms and signing contract documents, and thereby increasing the rate of successful contracts.

### BRIEF DESCRIPTION OF THE DRAWINGS

The structure as well as preferred modes of use, further objects, and advantages of this invention will be best understood by referring to the following detailed description of some illustrative embodiments in conjunction with the accompanying drawings, in which:

FIG. 1 is a block diagram of an online contract signing system according to an embodiment of the invention.

FIG. 2 is a schematic diagram illustrating a page provided by an online contract signing system for a contract initiator to create a contract document according to an embodiment of the invention.

FIG. 3 is a schematic diagram illustrating a page provided by an online contract signing system for a contract initiator to preview and update a contract document according to an embodiment of the invention.

FIG. 4 is a schematic diagram illustrating a page provided by an online contract signing system for a contract initiator to create a contract chatroom according to an embodiment of the invention.

FIG. 5 is a schematic diagram illustrating a message provided by an online contract signing system to an invitee according to an embodiment of the invention.

FIG. 6A is a schematic diagram illustrating a chatroom provided by an online contract signing system for a contract initiator and an invitee according to an embodiment of the invention.

FIG. 6B is a schematic diagram illustrating a chatroom provided by an online contract signing system for an invitee according to another embodiment of the invention.

FIG. 6C is a schematic diagram illustrating a chatroom provided by an online contract signing system for a contract initiator according to another embodiment of the invention.

FIG. 6D is a schematic diagram illustrating a page provided by an online contract signing system for a contract initiator to update a contract document according to another embodiment of the invention.

FIG. 7 is a schematic diagram illustrating a page provided by an online contract signing system for a contract initiator to proceed with online signing of an agreed contract document according to an embodiment of the invention.

FIG. 8 is a flow chart of an online contract signing method according to an embodiment of the invention.

### DETAILED DESCRIPTION OF THE PREFERRED EMBODIMENTS

The invention provides an online contract signing system and method for all parties, including a contract initiator and at least one invitee, to review a contract document directly while meeting in person and sign the contract online after approving the contract terms, or, the parties do not need to meet in person, just read and discuss the contract terms online, update the contract document right away, and sign the contract online after reaching an agreement. A copy of the signed contract is then sent to the terminal device or the email account of each party or is saved in the server. Simply put, the online contract signing system and method of the invention are convenient for the contract initiator and the invitee who are in progress of signing a contract and reduce the time and cost needed for discussion at face-to-face meeting, as well as reduce disputes derived from differences between discussed content and final amendment made. Thus, the rate of successful contracts is enhanced.

The online contract signing system and method of the invention are mainly executed by a server, wherein the software infrastructure of the online contract signing system is of a Software as a Service (SaaS) format, and so the terminal devices of the parties can use services through webpages provided by the server without having to install extra software. The terminal devices are, but not limited to, tablet computers, smart phones, laptop or notebook computers, desktop computers, or netbook computers. The invention does not limit the software infrastructure of the server, for example, the online contract signing system can be designed to have non-SaaS format and the parties need to install a specific software on their terminal devices to use the services provided by the server.

Moreover, the online contract signing system and method can be implemented in existing communication software and act as a plug-in that is either for a fee or free of charge, thereby eliminating the trouble of installing software on the terminal devices for the parties. For example, currently there are a lot of sellers sell their products through live-broadcast communication software, and if the transaction is protected by a contract, both parties, which are the seller and the buyer, are protected. Therefore, if the invention is implemented as a live-broadcast software plug-in, the seller can activate the plug-in to proceed with negotiation and sign the contract directly online with the buyer.

In general, the server includes a plurality of hardware circuits electrically connected to one another and a program code stored therein. The hardware circuits are, for example, a processing unit, a communication unit, a storage unit, and a memory unit, wherein the processing unit is electrically connected to the communication unit, the storage unit and the memory unit. The storage unit stores the program code so that after the processing unit accesses the program code, the tasks to be executed by the online contract signing system and method are performed. Also, the contract document of the invention is not limited to sale of goods, employment contract, or lease contract, but anything that requires signatures on a document can be done via the online contract signing system and method.

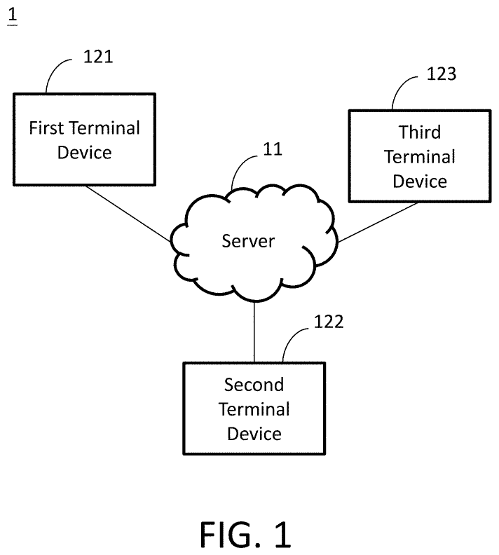

FIG. 1 is a block diagram of an online contract signing system according to an embodiment of the invention. The online contract signing system 1 is implemented through a server 11, and further includes a first terminal device 121, a second terminal device 122, and a third terminal device 123 that are connected to the server 11, wherein the connection is via wired or wireless communication but the invention is not limited thereby. The first terminal device 121, second terminal device 122, and third terminal device 123 are respectively operated by a first user, a second user, and a third user who may be respectively a first party, a second party and a third party in a contract document to be signed. However, the invention does not limit the number of signing parties in a contract, as long as there are more than two parties, and therefore, although three terminal devices 121, 122, 123 of three signing parties are illustrated in FIG. 1, two or more terminal devices of two or more signing parties are all that needed.

The online contract signing system 1 consists a SaaS framework, and so the three terminal devices 121, 122, 123 are able to use the services provided by the server 11 without having to install other software. The terminal devices can be tablet computers, smart phones, laptop computers, desktop computers, or netbooks, but the invention is not limited thereby. The three users/parties log into the server 11 via the terminal devices 121, 122, 123, and through the services provided by the server 11, one of the three parties creates a contract document. The party that created the contract document is a contract initiator, and the other two parties are the invitees. The contract initiator creates a contract chatroom for signing the contract, such that the parties, which include the contract initiator and the invitees, can discuss the terms in the contract document and make changes immediately, and all of the parties can sign the contract online once the terms of the contract document are agreed by the parties. Moreover, the signed contract document is sent to all of the parties, either to their terminal devices 121, 122, 123, email accounts, or is stored in the server 11.

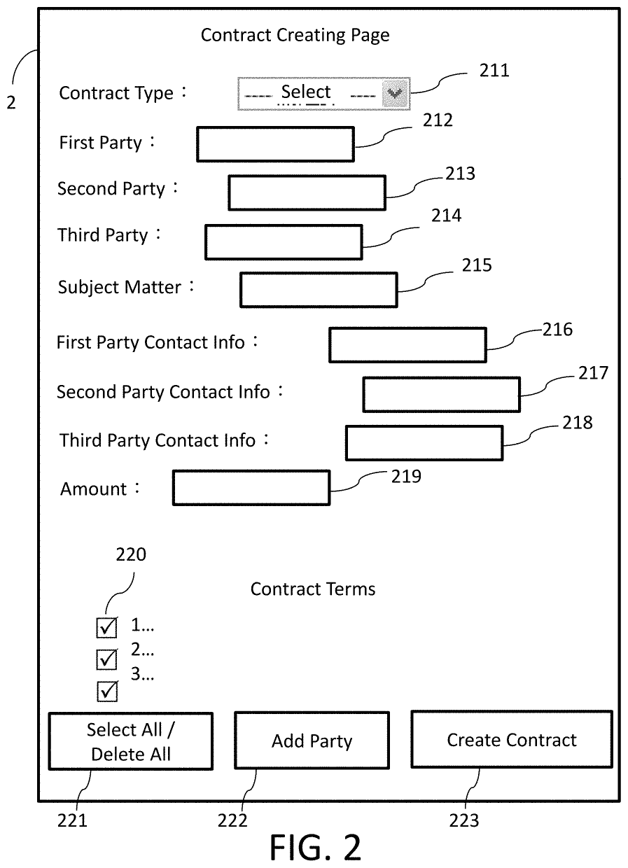

FIG. 2 depicts a page provided for the contract initiator to create a contract document according to an embodiment of the invention. Being one of the parties, the contract initiator logs into the server via the terminal device to create a contract document. Page 2 is a contract-creating page provided by the server 11 and the contract initiator selects a type of contract document to be created from a drop-down menu 211 named “contract type” or “document type”. The types of contract document include rental agreement, real estate sales contract, sale of goods contract, employment contract, communication service contract, teaching agreement, bid contract and etc.

After the contract initiator selects the type of contract, the terms of a contract template corresponding to the selection are shown to the contract initiator. The contract initiator can pick or cancel/delete all of the terms by using the “select all/delete all” button 221, or can pick some of the terms by clicking a selection box 220 beside each term to select each individual term one by one. In other words, the page 2 allows the contract initiator to select the contact type and pick some or all of the terms in the contract template.

In general, a contract is an agreement between two or more parties. Therefore, the page 2 further allows the contract initiator to fill in the names or titles of the parties in columns 212, 213, 214 that are respectively named “first party”, “second party”, and “third party”, and also to fill in the contact information of the parties in columns 216, 217, 218 that are respectively named “first party contact info”, “second party contact info”, “third party contact info”. The contact information is a cellular phone number, an email address, or an account registered by the party on the server of the online contract signing system or the server of other communication software. In this embodiment, the number of parties/signing parties is three, but the invention is not limited thereby, there can also be just two signing parties. The server of the online contract signing system transmits/sends a message containing a link of the contract chatroom to the first, second and third parties via their contact information, such that all of the parties can discuss the terms of the contract and sign the contract in the contract chatroom. The message is an email, a text message, or any other types of electronic notification. It is to be noted that in this embodiment, every party would receive the message containing the link of the contract chatroom, but in another embodiment, only the second and third parties, which are the invitees, receive the message containing the link of the contract chatroom, and the “first party contact info” column 216 can be left blank so as to not notify the first party, who is also the contract initiator.

Moreover, the page 2 also provides a “subject matter” column 215 and an “amount” column 219 for the contract initiator to fill in the name of the subject matter and the amount of mortgage. Commonly, the page 2 has more columns to input other data and more drop-down menus for selection to help the contract initiator create the contract more conveniently. In addition, if there are more than four parties, the page 2 provides an “add party” button 222 for the contract initiator to add the fourth or more parties. When the contract initiator completed filling out the information on the page 2, the contract initiator selects a “create contract” button 223 to generate the contract document, wherein at least a part of the information filled by the contract initiator on the page 2 is automatically input/filled into the contract document. In short, through the page 2, the terminal device of the contract initiator uses the selection and input content of the contract initiator as the input data of the server to create the contract document customized by the contract initiator.

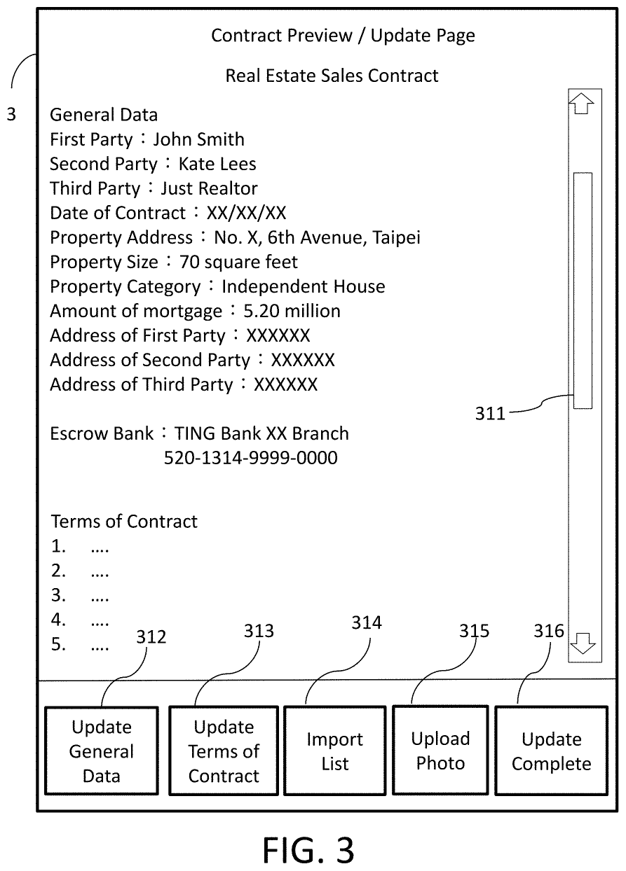

Referring to FIG. 3, this shows a page where the contract initiator previews and updates the contract document according to an embodiment of the invention. After the contract initiator created the contract document, the contract document may still need some amendment, and so the server of the online contract signing system provides a page 3 for the contract initiator to preview and update the contract document. In the page 3, the contract initiator scrolls the displayed content of the contract document up and down via a scroll bar 311 on the right side of the page 3, so as to review all of the contents in the contract document. When the contract initiator finds a mistake in the general data of the contract, a “update general data” button 312 can be selected to change, add, and delete the general data, and if the terms in the contract need to be amended, a “update terms of contract” button 313 can be selected to amend, add, or cancel the contract terms.

Further, the page 3 provides an “import list” button 314 and an “upload photo” button 315 for the contract initiator to import or upload a list, a photo or a file related to the subject matter or the parties as a part of the contract document. For example, in this embodiment, the contract document is a real estate sales contract so the list could be a key list, a furniture list and/or an appliance list, and the photo could be the house showing its condition, or a picture ID of the signing parties. Once the contract initiator is satisfied with the contract document and no more updating is required, the contract initiator selects an “update complete” button 316 to generate the updated contract document by the contract initiator.

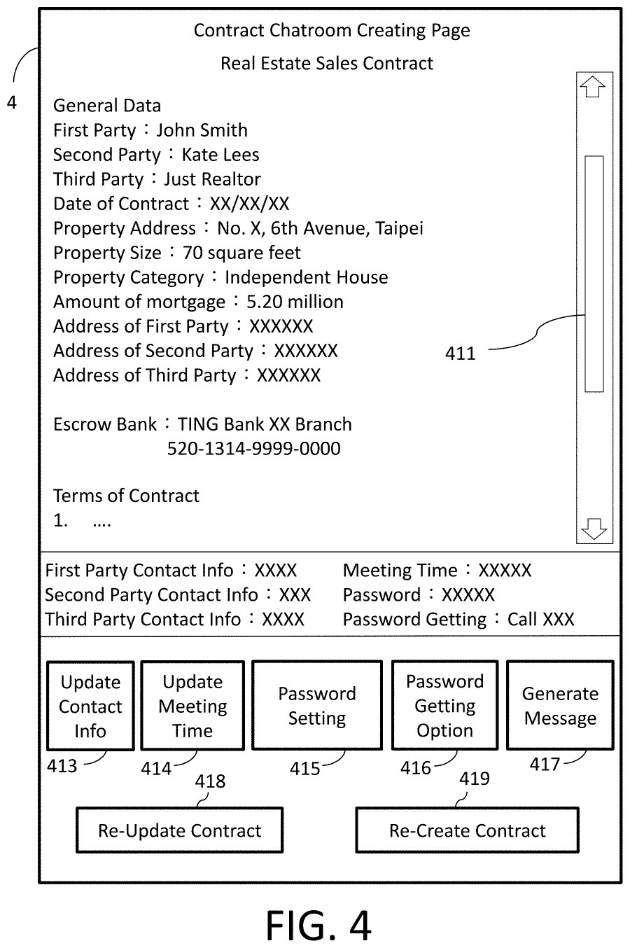

FIG. 4 illustrates a page where the contract initiator creates a contract chatroom according to an embodiment of the invention. After the contract initiator has created and updated the contract document, the online contract signing system provides a page 4 for the contract initiator to create a contract chatroom, as shown in FIG. 4. The contract initiator can scroll the updated contract document up and down to see its contents displayed on the page 4 by using a scroll bar 411 positioned on the right side of the page 4, and if the contract initiator wants to re-update or re-create the contract document, a “re-update contract” button 418 or a “re-create contract” button 419 can be selected.

Furthermore, if the contract initiator finds the contact information of at least one of the contract initiator and the invitee is incorrect, an “update contact info” button 413 can be selected to update, add, or delete the contact information of the parties. The page 4 also provides a “change meeting time” button 414, a “password getting option” button 415, and a “password setting” button 416, wherein the contract initiator is able to select the “change meeting time” button 414 to change a meeting time for the contract chatroom, select the “password setting” button 416 to setup a password for joining the contract chatroom, and select the “password getting option” button 415 to pick how the invitees can get the password. Lastly, the contract initiator selects a “generate message” button 417, whereby the server of the online contract signing system generates a message containing a link of the contract chatroom and sends the message to all of the listed parties: the contract initiator and the invitees. In other embodiments, it is possible that only the invitees such as the second party and the third party receive the message containing the link of the contract chatroom.

For instance, in this embodiment, if the first party is the contract initiator who created the contract chatroom, then the second party and the third party would not have known the password setup by the first party, so the password getting could be that the second party and the third party need to call the first party for the password to join the contract chatroom. Of course the aforementioned password getting could also be that the second and third parties connect to a specific webpage and answer questions on the specific webpage, and based on their answers the identity of the second and third parties are verified and thus the password is given. In short, the online contract signing system of the invention further provides an identity verification function for verifying the invitees of the parties. In other embodiments, identity verification of the invitees could be ignored and instead, a password is sent directly to the second party and the third party, or the invitees, wherein the password is, for example, a one-time password for use at a specific time; in other words, the password getting is written in the message containing the link the contract chatroom.

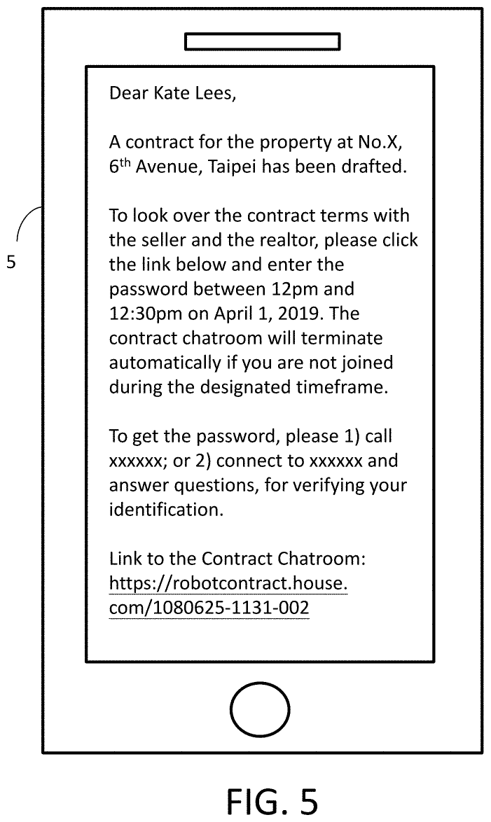

Next, referring to FIG. 5 for a message provided to the invitee according to an embodiment of the invention. The message containing the link of the contract chatroom shown in FIG. 5 is displayed on a terminal device 5 of the invitee, and is a text message, an email, or other types of electronic notification. In the embodiment of FIG. 5, there are two kinds of the password getting, one of which is for the invitee to call the contract initiator for the password, and the other is to connect to a specific webpage and get the password by answering questions for identity verification. Moreover, the message can be sent to the contract initiator for reminding the contract initiator of the meeting time for the contract chatroom and the contract initiator can join the contract chatroom by simply clicking the link. The contract chatroom can only be joined by the invitees at a specific time within a designated timeframe, whereas if any invitee did not join the contract chatroom on time, the online contract signing system would automatically terminate/close the contract chatroom and abandon the contract document.

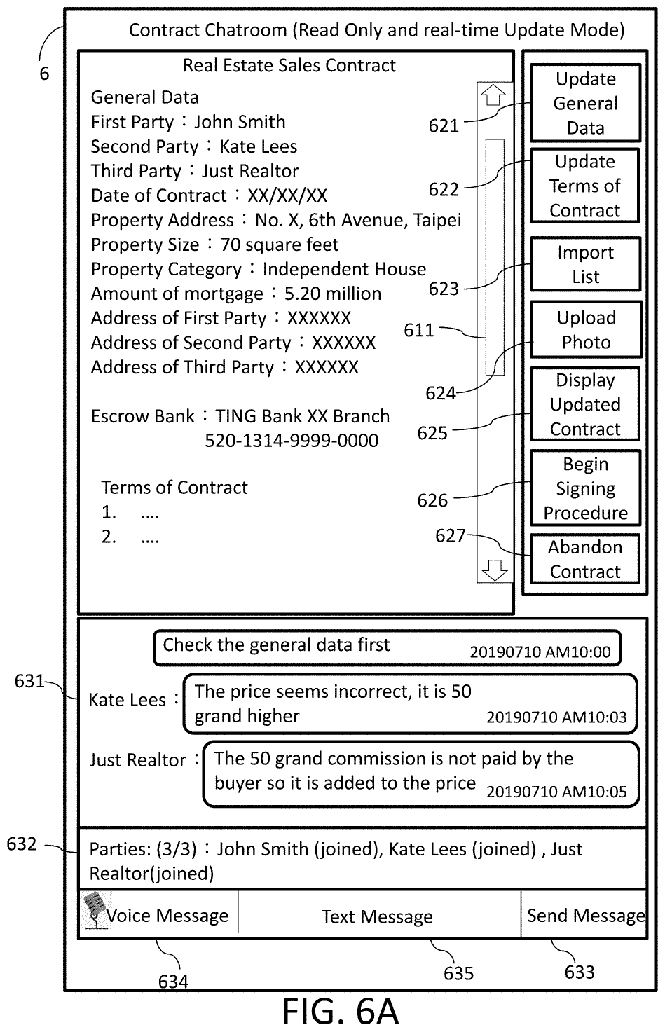

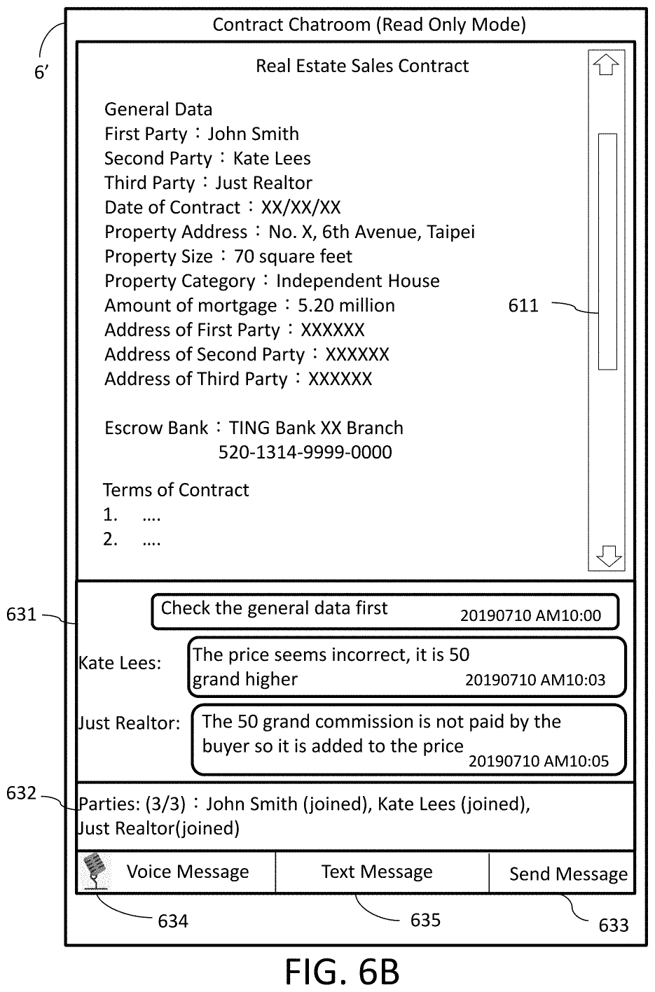

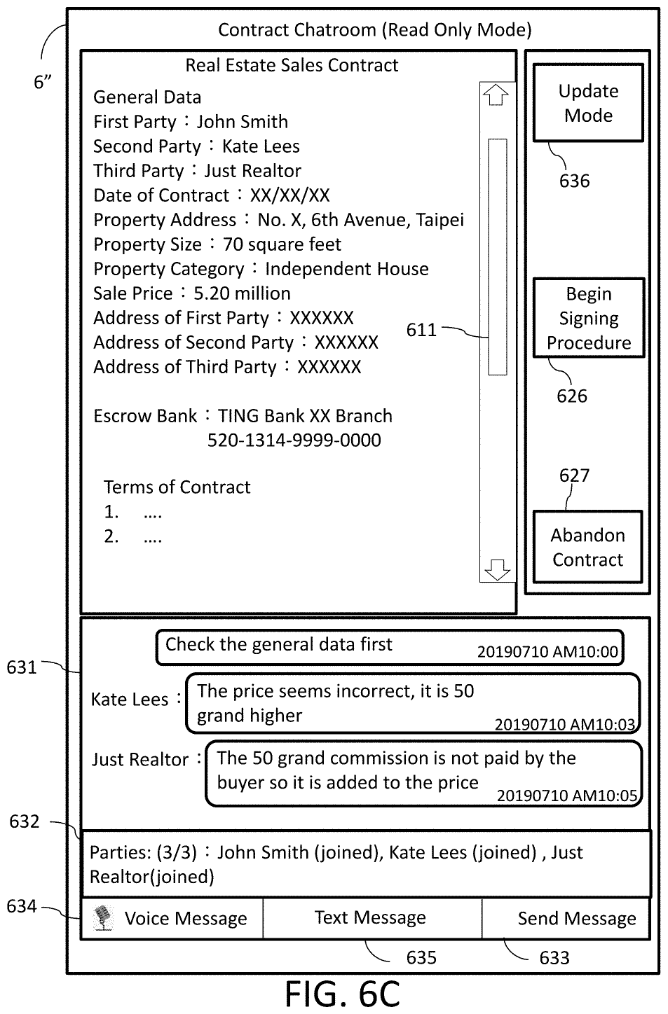

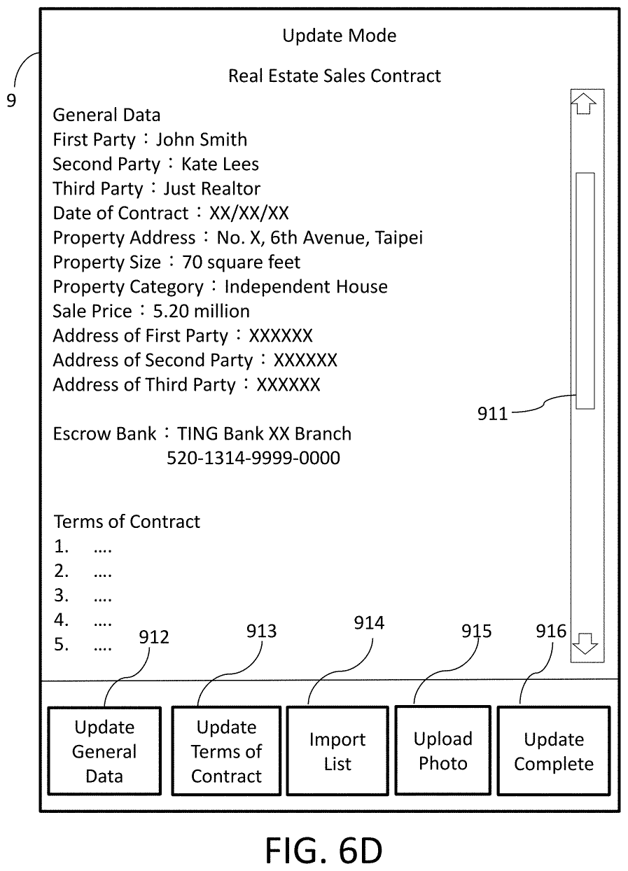

FIG. 6A shows a page of the contract chatroom provided by the online contract signing system to the contract initiator or the invitee according to an embodiment of the invention. Referring to FIG. 6A, when all of the parties, i.e. the contract initiator and the invitees, log into the server of the online contract signing system via their terminal device and enter the password to join the contract chatroom within a timeframe of the meeting time, a page 6 is provided to each party. The page 6 illustrates a chatroom interface of the contract chatroom, wherein the contract document is shown on the left side of the page 6 and that the contract initiator is able to scroll the content of the contract document up and down via a scroll bar 611 on the right side while explaining the terms and content of the contract to the invitees. In this embodiment, the contract initiator is the first party, and the invitees are the second party and the third party. Although the scroll bar 611 in this case is designed to be only scrollable by the contract initiator, the invention is not limited thereby, in other embodiments the scroll bar 611 can be designed to be scrollable by the invitee.

On the bottom of the page 6 is a conversation box 631, a status box 632, a “voice message” button 634, a text message area 635, and a “send message” button 633, wherein the “voice message” button 634 and the “text message” area 635 are provided by the page 6 for the invitee or the contract initiator to input voice messages and text messages, and the “send message” button 633 is provided for the parties to send the voice messages or the text messages to conversation box 631. In addition, the conversation box 631 displays the time and content of each text or voice message, and the status box 632 shows whether all of the parties have joined the contract chatroom and the time at which they joined. The page 6 further provides, on the right side, a “update general data” button 621, an “update terms of contract” button 622, an “import list” button 623, an “upload photo” button 624, a “display updated contract” button 625, a “begin signing procedure” button 626, and an “abandon contract” button 627.

The “update general data” button 621, the “update terms of contract” button 622, the “import list” button 623, the “upload photo” button 624 are the same as the “update general data” button 312, the “update terms of contract” button 313, the “import list” button 314, and the “upload photo” button 315 in functionality, and thus are not described herein. As the buttons 621-624 allow the first party to make changes to the terms and contents of the contract document according to the opinions of the second and third parties, the contents of the updated contract document is displayed by the first party by selecting the “display updated contract” button 625 to notify the second and third parties that the terms and content of the contract has been changed and updated. The notification is for example a text message of “the contract document has been updated” shown in conversation box 631. Moreover, once every party is satisfied with the terms of the updated contract, the first party can select the “begin signing procedure” button 626 to proceed with subsequent online signing of the contract. If one of the parties finds it impossible to continue the discussion/negotiation, the first party can select the “abandon contract” button 627 to terminate the contract chatroom and its' page.

It is to be noted that in the aforementioned embodiment, only the terminal device of the first party being the contract initiator acts as the control side (i.e. under the control of the server, the terminal device of the first party is a control side) can operate the scroll bar 611 and the buttons 621-627 on the page 6, whereas the terminal devices of the second and third parties being the invitees act as sink sides (i.e. under the control of the server, the terminal devices of the second and invitees are sink sides) can only view the display of the contract document, but cannot operate the scroll bar 611 and the buttons 621-627. The display of the contract document must be the same for both the contract initiator and the invitees. Simply put, when the terminal device of the first party acting as the control side is scrolling the displayed content, the displayed content on the terminal devices of the second and third parties acting as the sink sides is also synchronized thereto, in other words, only the control side is authorized to lead the display of the contract contents, and select the buttons 621-627 to use functions like update general data, update terms of contract, import list, upload photo, display updated contract, begin signing procedure, and abandon contract, whereas the sink side does not have the authorization for the aforementioned functions. However, the invention is not limited thereby, in other embodiments, all or some of the invitees can also be authorized to use the buttons 621-627 on the right side of the page 6. For example, the terminal device of the contract initiator is not set to be the control side but the invitee, and that is, the terminal device of the invitee acts as the control side while the terminal device of the contract initiator acts as the sink side. Although the contract initiator can explain the contract to the invitee, the function buttons 621-627 and scroll bar 611 on the page 6 are operated by the invitee, not the contract initiator.

In addition, the server could record a meeting minutes of the contract chatroom via video and audio recording so as to keep a record of the conversation, both text and voice messages, and the meeting minutes is stored in the server and/or sent to the terminal device of all parties and their email accounts. The page 6 further includes a “record meeting minutes” button (not illustrated in FIG. 6A). The recorded meeting minutes can be used to clarify disputes/issues which may be raised in the future by the parties about the contract.

The embodiment illustrated in FIG. 6A is a contract chatroom in a read only and real time updating mode, wherein the contract chatroom displays the contract while it is being updating and upon completion of the update. However, the read only mode and the updating mode can be separated according to another embodiment of the invention. The page 6 in FIG. 6A is provided to both the control side and the sink side, but since only the control side is authorized to use the functions, not the sink side, a read only mode page 6′ as shown in FIG. 6B is provided to the sink side and a read only mode page 6″ as shown in FIG. 6C is provided to the control side according to another embodiment of the invention. Referring to FIGS. 6B and 6C, the terminal device of the invitee is the sink side and the terminal device of the contract initiator is the control side, and therefore the page 6′ of the contract chatroom can only allow the invitee to send text messages and voice messages to the conversation box 631, and the page 6″ of the contract chatroom allows the contract initiator to select an “update mode” button 636 after reviewing the opinions of the invitee.

FIG. 6D shows a page provided by the server for the contract initiator to update the contract according to another embodiment of the invention. After the contract initiator selects the “update mode” button 636, the server provides a page 9 to the contract initiator. The page 9 includes a scroll bar 911, a “update general data” button 912, an “update terms of contract” button 913, an “import list” button 914, an “upload photo” button 915, and an “update complete” button 916, which are the same as the scroll bar 311 and buttons 312-316 of the page 3 in functionality, and therefore are not described herein again. Once the contract initiator selects the “update complete” button 916 on the page 9, the pages 6′ and 6″ would update the contract content and notify the contract initiator and the invitee that the contract has been updated, such that the contract initiator and the invitee can review and discuss about the updated contract.

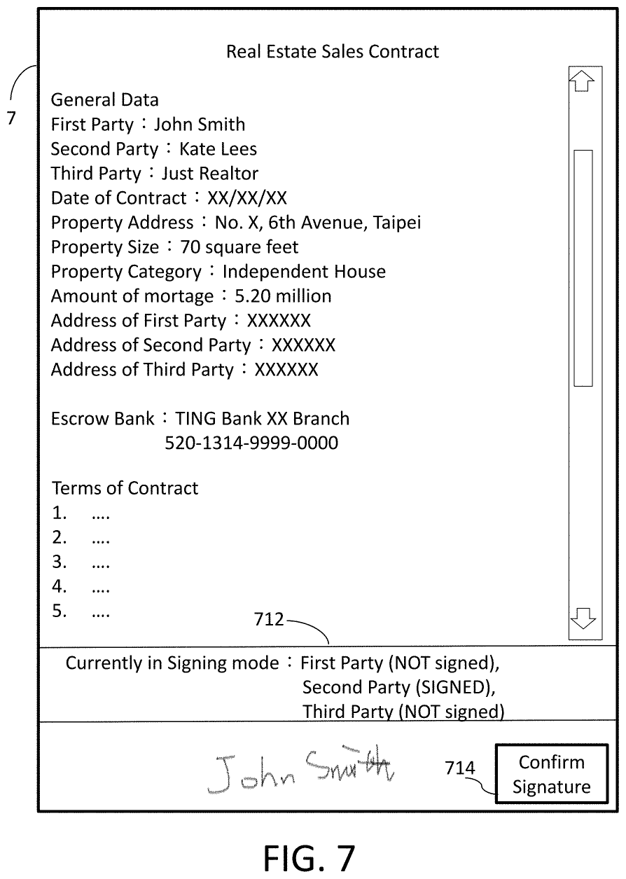

FIG. 7 is a page provided to the contract initiator for signing an agreed contract online. In FIG. 7, page 7 provides an online signing service to the contract initiator for signing the agreed contract, and after the contract initiator signed the agreed contract, a “confirm signature” button 714 is selected to complete the signing step. The agreed contract is the contract document which is mutually agreed by the parties. When all the parties have signed the agreed contract, the online signing procedure is complete. Then, the signed contract is sent to the terminal device of the parties, their email accounts, or is stored in the server of the online contract signing system. Moreover, the page provided to the invitee for signing the agreed contract is similar to that of the FIG. 7, and thus is not described herein. Furthermore, the page 7 includes a signing status box 712 that shows the signing status of all parties.

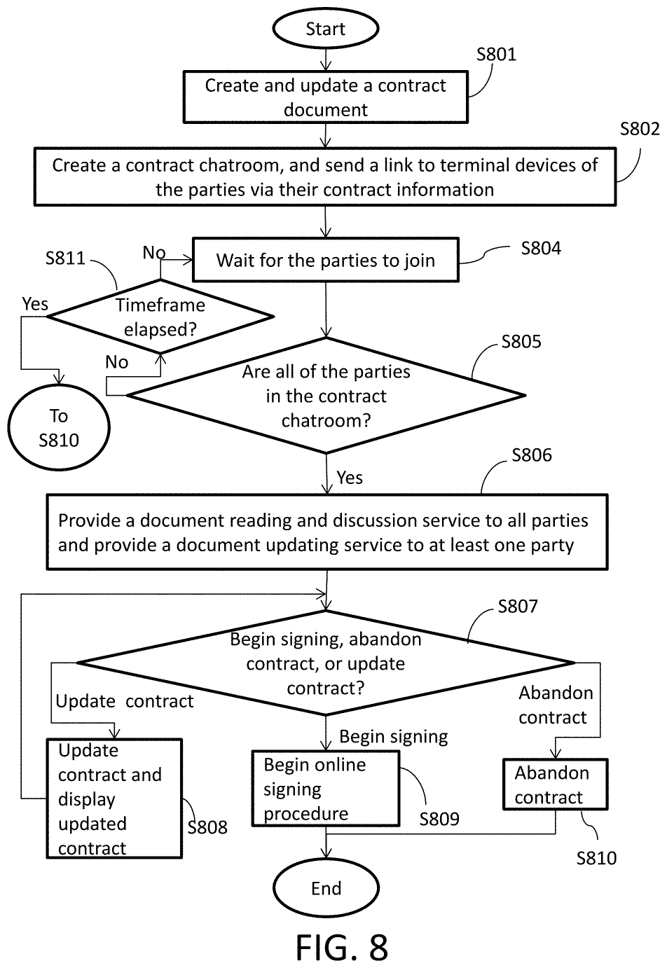

FIG. 8 is a flow chart of an online contract signing method according to an embodiment of the invention. First, in step S801, a server provides a contract document creatable by a contract initiator, and the created contract document is updateable by the contract initiator to generate an updated contract document, wherein the contract document is created based on data input by the contract initiator. Next in step S802, the server provides a contract chatroom creatable by the contract initiator for discussing, in synchronization or not, updating the contract document, and sends an electronic message containing a link of the contract chatroom to a terminal device of all parties via contact information of the parties got from the contract document. Then the server waits for all the parties to join the contract chatroom at a meeting time in step S804, wherein the parties are supposed to join the contract chatroom at the specific meeting time within a designated timeframe.

Step S805 determines whether all of the parties joined the contract chatroom, if so, step S806 is executed, otherwise go to step S811. In step S811, the designated timeframe is checked to determine whether the contract chatroom has expired, in other words, the contract chatroom is expired if the designated timeframe has elapsed and not all of the parties have joined the contract chatroom. If the contract chatroom is expired, skip to step S810, or else execute step S804 to continue waiting until all of the parties joined the contract chatroom. Subsequently, in step S806, the server provides a document reading and discussion service to all parties in the contract chatroom so each party can discuss and read the content of the contract document. In addition, the server provides a document updating service to at least one of the parties so the at least one party like the contract initiator can update the contract document according to the discussion, wherein the document updating service includes contract term amendment, general data correction, photo upload, and list importation.

Then, in step S807, the server determines whether a begin signing command, an abandon contract command, or a contract updating command is received. If the server receives the contract updating command, step S808 is executed; if the server receives the begin signing command, step S809 is executed; and if the server receives the abandon contract command, step S810 is executed. In step S808, the server updates the contract document based on the update command input by the party and displays the updated contract document, and after step S808, the server executes step S807. In step S809, the server provides the parties an online signing procedure/service to the contract document mutually agreed by the parties, and in step S810, the server abandons the contract document and terminates the contract chatroom.

Moreover, the online contract signing system and method further can translate the contract document automatically, such that the contract document seen by the invitee who joined the contract meeting is in their native language, or in multi-language. In other words, the online contract signing system and method are capable of converting and translating the text of the contract document to a target text corresponding to a language preference of the invitee. Thus, the invalidation issue of the signed contract due to the contract document being not written in the native language of a specific invitee is prevented. Also, the online contract signing system can be designed to allow the contract initiator and the invitee to print out the agreed contract and meet at a designated location to sign the contract together in person.

In view of above, the online contract signing system and method as described by the embodiments of the invention allow the contract initiator to explain the content of the contract document to the invitee and to amend the contract terms in real time according to the invitee's opinions until all parties agree to the contract terms and then let the parties sign the agreed contract online. Hence, the online contract signing system and method of the invention reduces the time and cost spent on contract discussion and contract signing, and thus can effectively enhance the rate of successful contracts.

The above disclosure is only the preferred embodiment of the present invention, and not used for limiting the scope of the present invention. All equivalent variations and modifications on the basis of shapes, structures, features and spirits described in claims of the present invention should be included in the claims of the present invention.

1. An online contract signing system comprising:
a server comprising a plurality of hardware circuits electrically connected to one another for executing a program code, whereby the server provides a contract document creatable by a contract initiator, a contract chatroom creatable by the contract initiator, a document reading and discussion service to the contract initiator and at least one invitee who joined the contract chatroom, and a document updating service to at least one of the contract initiator and the invitee, wherein under control of the server, one of terminal devices of the contract initiator or the invitee is a sink side, and another one of the terminal devices of the contract initiator or the invitee is a control side.

2. The online contract signing system of claim 1, wherein the server further provides an online signing service for the contract initiator and the invitee to sign the contract document mutually agreed by the contract initiator and the invitee.

3. The online contract signing system of claim 1, wherein the contract initiator inputs contact information of the contract initiator and the invitee to the server and the server transmits a link of the contract chatroom to the terminal devices of the contract initiator and the invitee via the contact information thereof.

4. The online contract signing system of claim 1, wherein the server further transmits a password or a password getting for joining the contract chatroom to the terminal devices of the contract initiator and the invitee via the contact information.

5. The online contract signing system of claim 1, wherein the server further allows at least one of the contract initiator and the invitee to abandon the contract document and the server terminates the contract chatroom.

6. The online contract signing system of claim 1, wherein the document updating service comprises amending terms of contract, correcting general data, uploading photos and importing lists, and after the contract document is updated, the server displays the updated contract document in the contract chatroom.

7. The online contract signing system of claim 1, wherein the server further translates a text of the contract document into a target text corresponding to a language preference of the invitee.

8. The online contract signing system of claim 1, wherein the document reading and discussion service comprises allowing the contract initiator and the invitee to communicate by inputting text messages or voice messages.

9. The online contract signing system of claim 1, wherein the server further records a meeting minutes of the contract chatroom.

10. The online contract signing system of claim 4, wherein the password is an one-time password for use at a specific time.

11. An online contract signing method comprising:
providing a contract document creatable by a contract initiator;
providing a contract chatroom creatable by the contract initiator;
providing a document reading and discussion service to the contract initiator and at least one invitee who joined the contract chatroom; and
providing a document updating service to at least one of the contract initiator and the invitee;
wherein one of the terminal devices of the contract initiator or the invitee, which is provided with the document updating service, is controlled to act as a control side, and another one of the terminal devices of the contract initiator or the invitee, which is provided with the document reading and discussion service, is controlled to act as a sink side.

12. The online contract signing method of claim 11, further comprising:
providing an online signing service for the contract initiator and the invitee to sign the contract document mutually agreed by the contract initiator and the invitee.

13. The online contract signing method of claim 11, further comprising:
receiving contact information of a contract initiator and at least one invitee; and
transmitting a link of a contract chatroom to the terminal devices of the contract initiator and the invitee via the contact information thereof.

14. The online contract signing method of claim 11, further comprising:
transmitting a password or a password getting for joining the contract chatroom to the terminal devices of the contract initiator and the invitee via the contact information.

15. The online contract signing method of claim 11, further comprising:
receiving an abandon contract command from at least one of the contract initiator or the invitee; and
terminating the contract chatroom.

16. The online contract signing method of claim 11, wherein the document updating service comprises updating terms of contract, updating general data, uploading photos, and importing lists, and after the contract document is updated, the updated contract document is displayed in the contract chatroom.

17. The online contract signing method of claim 11, further comprising:
translating a text of the contract document into a target text corresponding to a language preference of the invitee.

18. The online contract signing method of claim 11, wherein the document reading and discussion service comprises allowing the contract initiator and the invitee to communicate by inputting text messages or voice messages.

19. The online contract signing method of claim 11, further comprising:
recording a meeting minutes of the contract chatroom.

20. The online contract signing method of claim 11, wherein the password is an one-time password for use at a specific time.
